(19) United States
(12) Patent Application Publication
(10) Pub. No.: US 2022/0205350 A1
(43) Pub. Date: Jun. 30, 2022

(54) PREDICTIVE DRILLING DATA CORRECTION

(71) Applicant: Landmark Graphics Corporation, Houston, TX (US)

(72) Inventors: Misael Luis Santana, Katy, TX (US); Ashish Kishore Fatnani, Bengaluru (IN); Shashwat Verma, Bengaluru (IN); Shreshth Srivastav, Noida (IN); Sridharan Vallabhaneni, Bangalore (IN)

(21) Appl. No.: 17/134,626

(22) Filed: Dec. 28, 2020

(51) Int. Cl. E21B 44/00; G01V 1/50; G01V 1/46; G06K 9/62

(52) U.S. Cl. CPC E21B 44/00; G01V 1/50; G06N 3/08; G06K 9/6256; G01V 1/46

(57) ABSTRACT

A drilling data analytics engine disclosed herein automatically corrects drilling data with predictive modeling. A drilling data quality analyzer segregates drilling data into good drilling data and bad drilling data that has missing, incomplete, or incorrect entries. For each bad data entry in the bad drilling data, the drilling data analytics engine preprocess drilling data attribute values for the corresponding task not including the drilling data attribute value for the bad data entry and inputs the preprocessed drilling data attribute values into a trained predictive model. The trained predictive model is trained on good drilling data to estimate values for the drilling attribute corresponding to the bad data entry.

### TECHNICAL FIELD

The disclosure generally relates to the field of data correction and to predictive analytics for drilling operations.

### BACKGROUND

Predictive analytics are a wide array of statistical techniques and models that use past or present data to make predictions about future outcomes. Predictive analytics is performed using a variety of predictive models including regression models, neural networks, support vector machines, decision trees, clustering, etc. The type of predictive model can determine the resulting complexity of the predictions and more complex predictive models such as neural networks can be used to predict more complex outcomes.

### BRIEF DESCRIPTION OF THE DRAWINGS

Embodiments of the disclosure may be better understood by referencing the accompanying drawings.

FIG. 1 is a schematic diagram of a drilling data analytics system for correcting drilling data entries using predictive models.

FIG. 2 is a schematic diagram for training predictive models to estimate drilling data entries.

FIG. 3 is a flowchart of example operations for correcting a drilling data entry with predictive analytics.

FIG. 4 is a flowchart of example operations for training a drilling model to estimate a drilling data attribute.

FIG. 5 depicts an example computer system with a drilling data predictive analytics engine and a predictive drilling model trainer.

FIG. 6 is a schematic diagram of a drilling rig system with a drilling analytics system.

FIG. 7 depicts a schematic diagram of a wireline system with a drilling analytics system.

FIG. 8 is a flowchart of example operations for generating candidate corre3ctions for a flaw in subterranean operation data with a predictive model.

### DESCRIPTION OF EMBODIMENTS

The description that follows includes example systems, methods, techniques, and program flows that embody embodiments of the disclosure. However, it is understood that this disclosure may be practiced without these specific details. For instance, this disclosure refers to prediction and correction of drilling data attribute values for tasks in a drilling operation in illustrative examples. Embodiments of this disclosure can be instead applied to prediction and correction of task data for other task-oriented operations. In other instances, well-known instruction instances, protocols, structures and techniques have not been shown in detail in order not to obfuscate the description.

### Overview

A drilling analytics system disclosed herein segregates data for a drilling operation into “good” and “bad” drilling data and uses predictive modeling to facilitate efficient correction of bad drilling data. First, a predictive drilling model trainer trains predictive models to estimate attributes of the drilling data (e.g., drilling phase, task code, etc.). Each predictive drilling model is trained to estimate a distinct drilling data attribute. Subsequently, the drilling analytics system applies data quality rules to drilling data to detect missing, incomplete, or incorrect entries (i.e., “bad” drilling data). For each data entry detected as bad drilling data, a predictive model corresponding to the drilling data attribute for that data entry is used. The drilling analytics system inputs drilling operation data for other drilling attributes corresponding to a drilling task for the data entry into the predictive model, and the predictive model generates estimates for the data entry and corresponding confidence values. The drilling analytics system supplies estimates for the data entry having a high confidence value or likelihood of being correct, as indicated by the output of the predictive model, to a user interface for data correction. The resulting estimates comprise a refined list of potential updates to the data entry that allows for efficient data completion by an operator.

### Example Illustrations

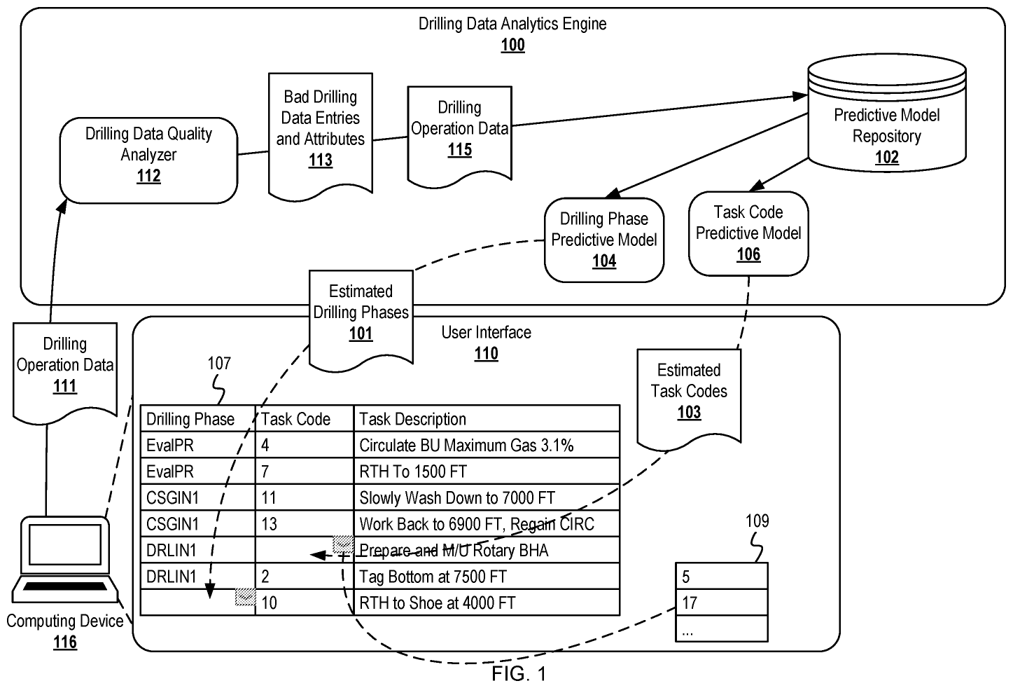

FIG. 1 is a schematic diagram of a drilling data analytics system for correcting drilling data entries using predictive models. A drilling data analytics engine 100 includes a drilling data quality analyzer 112 and a predictive model repository 102. The drilling data quality analyzer 112 receives drilling operation data 111 from a computing device 116. The drilling data quality analyzer 112 evaluates the drilling operation data 111 to determine bad drilling data entries and attributes 113. The drilling data quality analyzer 112 then communicates the bad drilling data entries and attributes 113 as well as drilling operation data 115 which is at least a subset of the drilling operation data 111 to the predictive model repository 102. The predictive model repository 102 retrieves predictive models corresponding to drilling data attributes in the bad drilling data entries and attributes 113 including a drilling phase predictive model 104 and a task code predictive model 106. The drilling data analytics engine 100 inputs drilling data from the drilling operation data 115 into the drilling phase predictive model 104 and the task code predictive model 106, to generate estimated drilling phases 101 and estimated task codes 103, respectively. The computing device 116 receives the estimated drilling phases 101 and estimated task codes 103 and uses them to correct bad drilling data entries via a user interface 110.

The computing device 116 can be running on the surface or in a bottomhole assembly for an oil or gas operation. The drilling operation data 111 can be any data characterizing tasks performed by the oil operation downhole and can indicate operations performed by one or more components of a bottomhole assembly (BHA). For instance, the drilling operation data 111 can include example drilling data 107 comprising values for drilling data attributes that include drilling phase, task code, and task description. The example drilling data 107 includes seven tasks illustrated in seven entries. The entries in the example drilling data 107 are with the drilling data attributes from left to right: drilling phase, task code, and task description. From top to bottom and left to right, the illustrated entries indicate: drilling phases of EvalPR, EvalPR, CSGIN1, CSGIN1, DRLIN1, DRLIN1 and a missing or “bad” drilling phase; task codes of 4, 7, 11, 13, a bad task code, 2, and 10; task descriptions of “Circulate BU Maximum Gas 3.1%,” “RTH To 1500 FT,” “Slowly Wash Down to 7000 FT,” “Work Back to 6900 FT, Regain CIRC,” “Prepare and M/U Rotary BHA,” “Tag Bottom at 7500 FT”, and “RTH to Shoe at 4000 FT.”. Although depicted as missing entries the bad drilling phase and bad task code can be data entries that are incomplete or incorrect for each respective drilling attribute. The drilling operation data 111 may not indicate which of the drilling data entries are bad as this can be determined by the drilling data quality analyzer 112. Although the drilling operation data 111 is depicted as being communicated from a computing device 116 at a drilling operation to the drilling data analytics engine 100, the drilling operation data 111 can be stored and maintained, after collection, in a separate database. This database can be a relational database to support efficient queries by the drilling data analytics engine 100.

The drilling data quality analyzer 112 evaluates the drilling operation data 111 to determine missing, incomplete, or incorrect (i.e., “bad”) data entries. Missing entries can comprise data entries with no values or NULL values. Incomplete or incorrect data entries can be determined by the drilling data quality analyzer 112 using one or more data quality rules. These rules can be user-specified (e.g., via the user interface 110) and can correspond to domain-level knowledge of the drilling data attributes specific to a particular drilling operation. For instance, a user can specify a list of drilling phases and each drilling phase outside this list can be classified as incorrect or incomplete. Data quality rules can be across drilling data attributes, for instance certain tasks can be paired with a list of task codes, and task codes that are not on the list for the corresponding task description can be classified as incorrect or incomplete. In embodiments where the drilling operation data 111 is a relational database, a user can construct queries in Structured Query Language (SQL), or any other programming language used for managing data on a relational database management system in order to determine incomplete or incorrect data entries. For instance, for a drilling attribute of “Task Time,” the user can write an SQL query for all tasks performed outside a range of known times during which a drilling operation was active. The resulting bad drilling data entries and attributes 113 comprise the bad drilling data entries and corresponding indications of drilling data attributes. The drilling operation data 115 comprises drilling data for tasks corresponding to the bad drilling data entries and attributes 113 as well as indications of the corresponding bad drilling data entries.

The predictive model repository 102 receives the bad drilling data entries and attributes 113 and the drilling operation data 115. The predictive model repository 102 can be indexed by drilling data attribute and can generate a query comprising unique drilling data attributes in the bad drilling data entries and attributes 113. In the embodiment depicted in FIG. 1, the drilling data attributes in the bad drilling data entries and attributes 113 comprise drilling phase, activity code, and activity description. Each of the predictive models 104 and 106 can be any predictive model trained to predict drilling data entries for a drilling data attribute based on inputting other drilling data attributes for the corresponding task as well as previous values for the drilling attribute. For instance, the drilling phase predictive model 104 is trained to predict a drilling phase value based on a task code value, a task description value, and previous drilling phase values, and the task code predictive model 106 is trained to predict a task code value based on a task description value, a drilling phase value and previous task code values. The resulting estimated drilling phases 101 and estimated task codes 103 output by the respective predictive models 104 and 106 can comprise multiple values for each data attribute corresponding to the most confident predictions (i.e., predictions having a highest likelihood values) for the model outputs. An example task code output 109 comprises at least two choices for the task code comprising task codes 5 and 17 which are presented to a user via a dropdown at the data entry on the user interface 110. A user interacting with the user interface 110 can evaluate the options provided for quality (e.g., by classifying each on a 1-10 scale), and this feedback can be used to improve predictive model quality (e.g., neural network quality) by augmenting the drilling data set used for training.

The predictive models 104 and 106 can be any predictive model trained using the inputs and outputs disclosed herein. For example, multiclass algorithms including, but not limited to, KNeighboursClassifier (KNN), Decision Tree, Random Forest, Support Vector Machines (SVM), Multi-layer Perceptron Classification (MLP) can be used. The predictive models 104 and 106 can include an embedded Natural Language Processor (NLP) that can preprocess the drilling operation data 115 to extract contextual information in the form of numerical vectors that are then used as input. Alternatively, the NLP can be a standalone component that is shared across multiple predictive models. The type of preprocessing steps by the NLP can vary depending on the type of predictive models used, and each NLP can correspond to a type of predictive model. Other preprocessing steps can be included before inputting the drilling operation data 115 into the predictive models 104 and 106. For example, each bad drilling data entry to be corrected by a predictive model can be compared to good drilling data entries as specified in the user-input rules to the drilling data quality analyzer 112, and a numerical vector of similarities between the bad drilling data entries and the good drilling data entries can be the input into the predictive models 104 and 106. The similarity can be, for instance, Euclidean distance between numerical vectors after the NLP is applied to the drilling data entries.

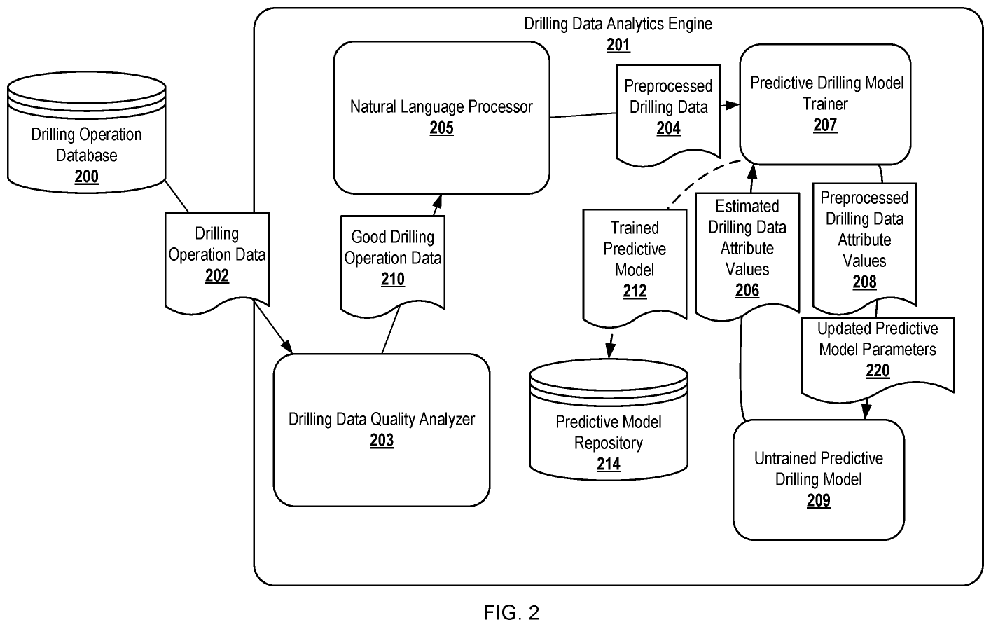

FIG. 2 is a schematic diagram for training predictive models to estimate drilling data entries. A drilling operation database 200 communicates drilling operation data 202 to a drilling data quality analyzer 203 embedded on a drilling data analytics engine 201. The drilling operation database 200 can send the drilling operation data 202 as it receives data from a drilling operation (not depicted) or can send the drilling operation data 202 in response to a query by the drilling data analytics engine 201. The query can be, for example, specific to a drilling operation and a time period for which the drilling operation was active. The drilling operation database 200 can be a relational database to facilitate efficient lookup of drilling data corresponding to a particular query.

The drilling data quality analyzer 203 evaluates the drilling operation data 202 to determine a set of good drilling operation data 210. The drilling data quality analyzer 203 can apply a set of user-specified or predetermined rules to the drilling operation data 202 to make the determination of whether data entries are good or bad. The drilling operation database 200 can be a relational database, and instead of directly evaluating the drilling operation data 202, the drilling data quality analyzer 203 can construct a query for good drilling operation data 210. For instance, an SQL query could specify a set of time period corresponding to a set of drilling operations, as well as lists values for drilling data attributes corresponding to each drilling operation/time period. Thus, the drilling operation database 200 returns drilling operation data 202 comprising data for the time periods/drilling operations with drilling data attributes all within the prescribed lists. These lists can be determined by a user based on expert domain knowledge of known operational conditions and logistics at each drilling operation. The good drilling operation data 210 can be for a specific drilling operation or across drilling operations depending on the desired scope of the resulting predictive model.

A natural language processor (NLP) 205 receives the good drilling operation data 210 and preprocesses it using natural language processing and/or other normalization techniques to generate preprocessed drilling data 204. The NLP 205 can extract tokens from textual information in the good drilling operation data 210 and can use an algorithm such as Word2vec to embed the drilling data attributes into a numerical space where distance represents semantic similarity. The natural language processing steps by the NLP 205 can be performed for each task represented in the good drilling operation data 210. Because the trained predictive model 212 will be trained to predict a single drilling data attribute, the NLP 205 can omit all other drilling data attributes before performing any preprocessing techniques. Alternatively, the NLP 205 can, after embedding values for each drilling data attribute into a semantic space, determine a similarity (e.g., using Euclidean distance) between the drilling data attribute value to be predicted and every other value for that drilling data attribute in the good drilling operation data 210. The resulting vector of similarities can be added to the preprocessed drilling data 204 for each task in the good drilling operation data 210. The preprocessed drilling data 204 can, for each input vector corresponding to each task in the good drilling operation data 210, additionally comprise an output vector that is the drilling data attribute value meant to be estimated by a predictive model.

The predictive drilling model trainer 207 receives the preprocessed drilling data 204 and initializes an untrained predictive drilling model 209. The untrained predictive drilling model 209 can be initialized to have a prescribed architecture and/or to predict a particular drilling data attribute based on user input. The architecture of the untrained predictive drilling model 209 can depend on the complexity of the drilling data attribute. For instance, a simple drilling data attribute such as a task code could use a support vector machine (SVM) whereas a more complex drilling data attribute such as drilling phase could use a deep neural network. After initialization, the predictive drilling model trainer 207 inputs preprocessed drilling data attribute values 208 into the untrained predictive drilling model 209. Each input can correspond to drilling data attributes values for a task without the drilling data attribute that the untrained predictive drilling model 209 is trained to predict. The untrained predictive drilling model 209 generates estimated drilling data attribute values 206. Based on the difference between the estimated drilling data attribute values 206 and corresponding drilling data attribute values in the preprocessed drilling data 204, the predictive drilling model trainer 207 sends updated predictive model parameters 220 to the untrained predictive drilling model 209. The predictive drilling model trainer 207 continues to update internal parameters of the untrained predictive drilling model 209 until a training criterion is satisfied. The training criterion can be, for instance, that the difference between the estimated drilling data attribute values 206 and corresponding drilling data attribute values in the preprocessed drilling data 204 (e.g., based on an error metric) or can be that a threshold number of iterations has been reached. In some embodiments, the training criterion accounts for a list of the top k (e.g., k=5, 10) most likely drilling data attribute values in the estimated drilling data attribute values 206. In this instance, the training criterion can be a false positive rate for the presence of the corresponding drilling data attribute value in the preprocessed drilling data 204 in the top k most likely drilling data attribute values. Once training has terminated, the predictive drilling model trainer 207 stores a trained predictive model 212 in a predictive model repository 214. Subsequent to model storage, existing trained predictive models in the predictive model repository 214 can be updated using additional drilling operation data collected by the drilling operation database 200. Confidence values for outputs of the predictive models, during training and deployment, can be used to evaluate the quality of data in the drilling operation database 200 and can be used to enhance data segregation by the drilling data quality analyzer 203.

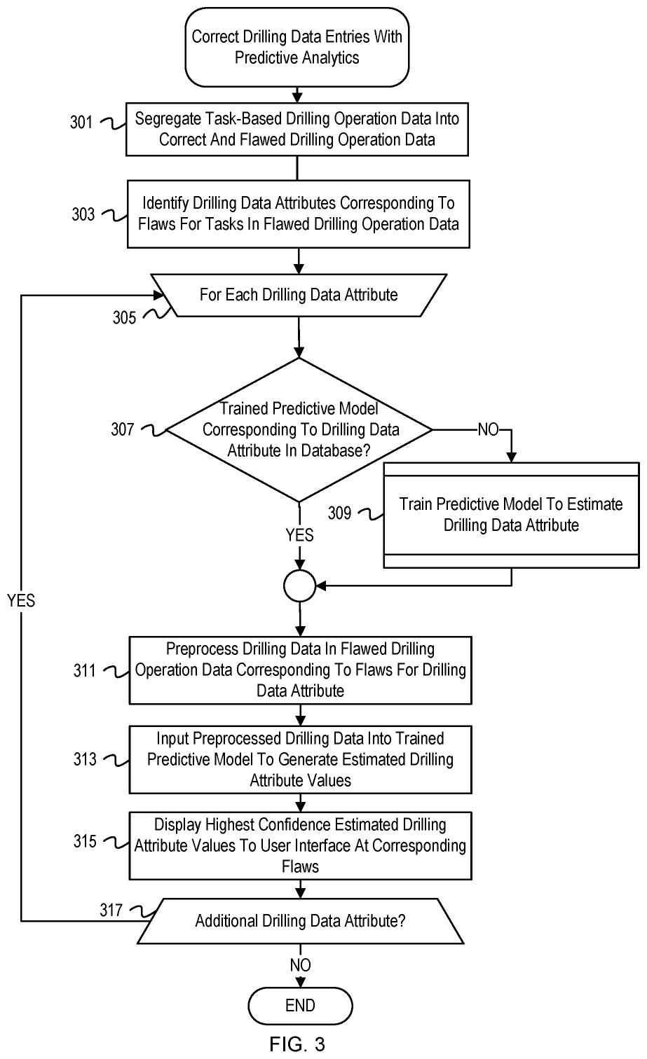

The example operations in FIGS. 3, 4, and 8 are described with reference to a drilling data analytics engine and a predictive drilling model trainer for consistency with the earlier figures. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for correcting drilling data entries with predictive analytics. At block 301, a drilling data analytics engine segregates task-based drilling operation data into correct and flawed drilling operation data. Data segregation can occur using data quality rules specific to a drilling operation, region of drilling operations, or other aggregation of oil or gas data belonging to a particular group or class. For instance, data quality rules can enforce that a time stamp for each task be between specific dates at which a drilling operation or region of drilling operations was operational. Values for operational thresholds such as load on components of the drilling operation(s), temperature and/or pressure on components, temperature and/or pressure downhole, etc. can be imposed. “Flawed” drilling operation data as used herein can comprise “bad” drilling operation data that has missing, incomplete, or incorrect entries as described variously above. “Correct” drilling operation data can comprise “good” drilling operation data that is drilling operation data that is not missing, incomplete, or incorrect (i.e., all of the data entries are correct according, at least, to data quality rules).

At block 303, the drilling data analytics engine identifies drilling data attributes corresponding to flaws for tasks in flawed drilling operation data. The drilling data analytics engine applies the aforementioned data quality rules to identify flaws in the data. The drilling data analytics engine may examiner properties of the drilling operation data to determine the applicable set of data quality rules. For instance, the drilling data analytics engine can read metadata of the drilling operation data that indicates a region and retrieve the applicable set of data quality rules based on the indicated region. The drilling data analytics engine can remove duplicates in the drilling attributes corresponding to flaws for tasks in the flawed drilling operation data. The deduplication of data can be performed as specified by the set of data quality rules or a data cleaning/pre-processing procedure defined in program code. In some embodiments, tasks can be grouped based on predictive models being available across each group of tasks. The drilling data analytics engine can only remove duplicate drilling attributes within each grouping of tasks.

At block 305, the drilling data analytics engine beings iterating through each drilling data attribute. In embodiments where the tasks are additionally grouped by availability of predictive models, the iterations can occur across drilling data attributes within each group. Example operations at each iteration are described in blocks 307, 309, 311, 313, 315, and 317.

At block 307, the drilling data analytics engine determines whether there is a trained predictive model corresponding to the current drilling data attribute in a database of predictive models. The query can comprise drilling operation data specific to the task and predictive models can be indexed by drilling operation or regions of drilling operations. The query can further comprise model architecture parameters such as number of internal parameters, model type, etc. These model architecture parameters can be specified by a user prior or simultaneous to correcting drilling data entries. If a trained predictive model is found in the database, operations skip to block 311. Otherwise, operations proceed to block 309.

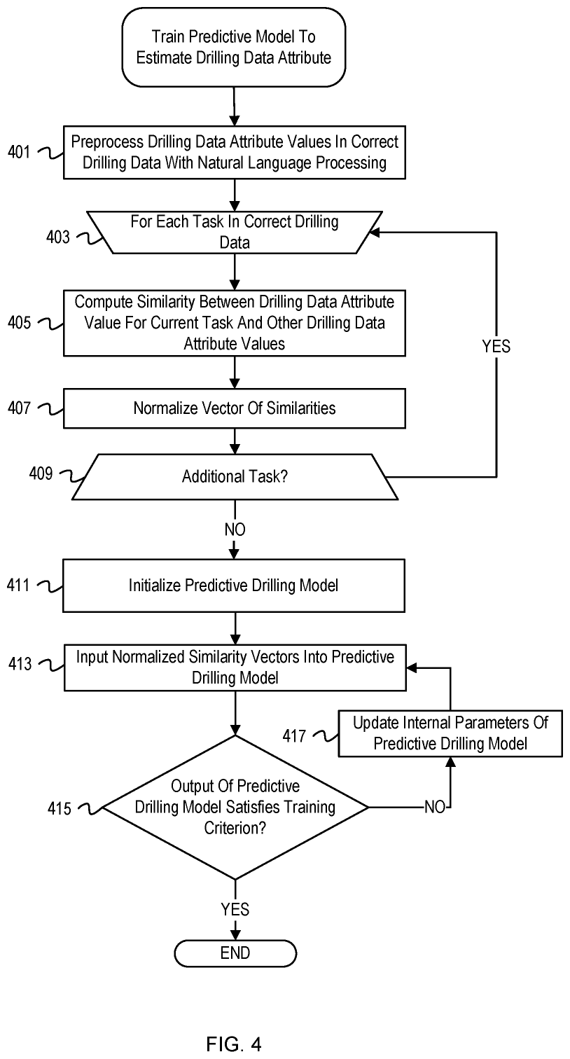

At block 309, the drilling data analytics engine trains a predictive model to estimate the current drilling data attribute. The operations at block 309 are described in greater detail with respect to FIG. 4.

At block 311, the drilling data analytics engine preprocesses drilling data in the flawed drilling operation data corresponding to flaws for the current drilling data attribute. The drilling data in the flawed drilling operation data that is preprocessed comprises values of drilling data attributes for tasks corresponding to flaws for the current data attribute. The preprocessing can comprise a natural language processing step where textual data in each drilling data attribute is tokenized and the tokens are embedded into a semantic space as numerical vectors to capture contextual and lexical information about each drilling data attribute. The preprocessing can comprise additional normalization steps and computation of similarities between the value for the current drilling data attribute (after applying natural language processing) and other values for the current drilling data attribute in known good drilling data. The preprocessing steps can depend on the type of predictive model and the format it takes as input, which can vary across tasks for the current drilling attribute.

At block 313, the drilling data analytics engine inputs preprocessed drilling data into the trained predictive model to generate estimated drilling data attribute values. The trained predictive model can be multiple predictive models specific to different groups of tasks. The corresponding preprocessed drilling data can also vary based on the type and architecture of predictive model being used. The resulting output of the predictive model(s) comprises both estimated drilling data attribute values and confidence values that indicate a likelihood of the prediction being correct.

At block 315, the drilling data analytics engine displays the highest confidence estimated drilling data attribute values for each trained predictive model to a user interface as possible candidate corrections at the data entries for the corresponding flaws. The number of estimated drilling data attribute values for each flaw can be a prespecified number of drilling data attribute values (e.g., 5), can be a threshold confidence value below which estimated drilling values are rejected, or can be another criterion. This criterion can be specified by a user based on the desired required accuracy of displayed corrections to flawed drilling data entries.

At block 317, the drilling data analytics engine determines whether there is an additional drilling data attribute. If there is another drilling data attribute, operations return to block 305. Otherwise, the operations in FIG. 3 are complete.

FIG. 4 is a flowchart of example operations for training a predictive model to estimate a drilling data attribute. At block 401, a predictive model trainer preprocesses drilling data attribute values in correct drilling data with natural language processing. The correct drilling data can be segregated from flawed (“bad”) drilling data using data quality rules and stored for subsequent training. Correct drilling data can be chosen for a drilling operation or region of drilling operations at which the predictive model is to be used. The predictive model trainer can tokenize drilling data attribute values in the correct drilling data that comprise textual data and can use a semantic word embedding such as Word2vec to capture lexical and contextual features of the drilling data attribute values. The correct drilling data, prior to or after preprocessing, can be split into training and testing data. The testing data can be set aside to be used to determine generalization error for the predictive model during training.

At block 403, the predictive model trainer begins iterating through tasks in the correct drilling data. The operations at each iteration are described at blocks 405 and 407.

At block 405, the predictive model trainer computes a similarity between a drilling data attribute value for the current task and values for that drilling data attribute for other tasks in the correct drilling data. For instance, the predictive model trainer can use semantic representations for each of the drilling data attribute values and compute a metric in the resulting vector space between the drilling data attribute value to be modeled by the predictive model and each of the other drilling data attribute values. Other notions of similarity, semantic or otherwise, can be used.

At block 407, the predictive model trainer normalizes the vector of similarities. The normalization can be based on a desired norm or other statistic of the similarity vector (e.g., mean, standard deviation) that renders it conducive to model training. This step can additionally depend on the type of predictive model and a statistical distribution of training data that most efficiently trains that model type.

At block 409, the predictive model trainer determines if an additional task is present in the correct drilling data. If an additional task exists, operations return to block 403. Otherwise, operations proceed to block 411.

At block 411, the predictive model trainer initializes a predictive drilling model. The initial parameters for the predictive model can be specified by a user or can be hard coded values based on the intended scope of the predictive model (a drilling operation, a region of drilling operations, etc.). Certain internal parameters can be randomly initialized, for instance certain internal layers can be initialized as a standard normal Gaussian distribution, to facilitate training with fewer iterations.

At block 413, the predictive model trainer inputs the normalized similarity vectors into the predictive drilling model. The predictive drilling model generates outputs comprising estimated values for the drilling data attribute. The normalized similarity vectors can be only those similarity vectors corresponding to the training subset of the correct drilling data. Additional values such as drilling attribute values for corresponding tasks can be used as additional inputs to the predictive model.

At block 415, the predictive model trainer determines whether the output of the predictive drilling model satisfies a training criterion. The training criterion can be that the error between outputs of the predictive drilling model and corresponding drilling data attribute values in the correct drilling data is sufficiently small across the training drilling data (i.e., that the training error is low). The training criterion can additionally comprise the criterion that the generalization error for the predictive model is sufficiently low, which can be verified by inputting similarity vectors for the testing data into the predictive model and comparing the outputs to the corresponding drilling data attribute values in the good drilling data. If the training criterion is not satisfied, operations continue to block 417. Otherwise, the operations in FIG. 4 are complete.

At block 417, the predictive model trainer updates internal parameters of the predictive drilling model. The internal parameters can be updated based on a difference between outputs of the predictive model on training data and corresponding drilling data attribute values in the correct drilling data. For instance, when the predictive model is a neural network, an error function on this difference can be computed and the error can be backpropagated through the network to generate updated values for internal nodes. Subsequently, operations proceed to block 413.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 405 and 407 can be performed in parallel or concurrently. With respect to FIG. 4, computing similarities between data attribute values is not necessary. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

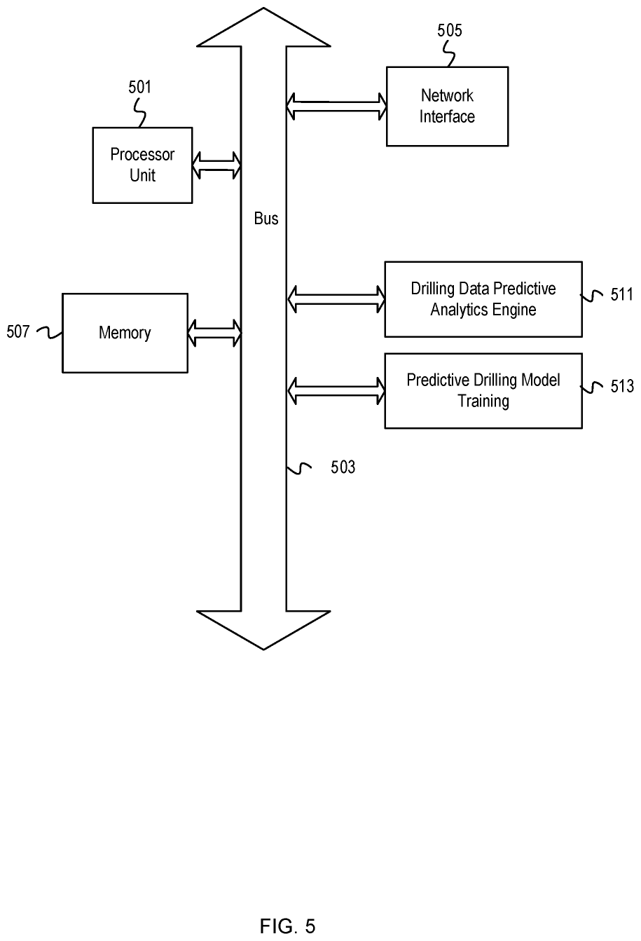

FIG. 5 depicts an example computer system with a drilling data predictive analytics engine and a predictive drilling model trainer. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system communicates via transmissions to and/or from remote devices via the network interface 505 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.). The system also includes a drilling data predictive analytics engine 511 and a predictive drilling model trainer 513. The drilling data predictive analytics engine 511 that can segregate drilling operation data into good drilling data and bad drilling data and can complete bad data entries in the bad drilling data using predictive drilling models for each drilling attribute in the bad data entries. The predictive drilling model trainer 513 can train predictive drilling models to predict values for a drilling attribute based on preprocessed drilling data attribute values corresponding to the same task, as described variously above. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

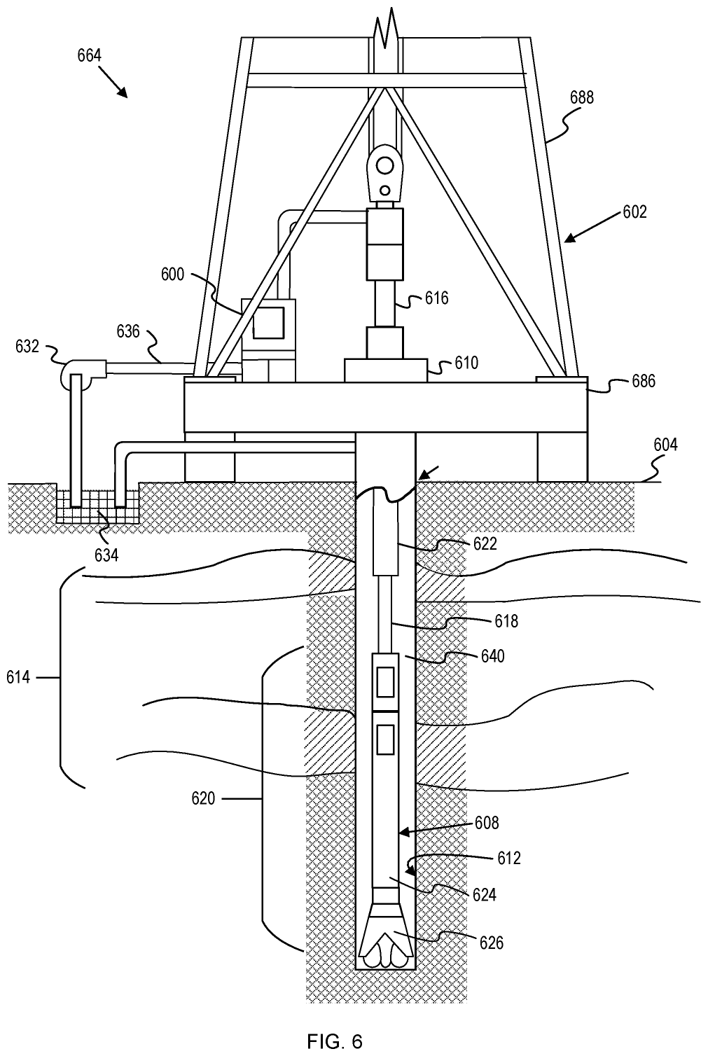

FIG. 6 is a schematic diagram of a drilling rig system with a drilling analytics system. For example, in FIG. 6 it can be seen how a system 664 may also form a portion of a drilling rig 602 located at the surface 604 of a well 606. Drilling of oil and gas wells is commonly carried out using a string of drill pipes connected together so as to form a drilling string 608 that is lowered through a rotary table 610 into a wellbore or borehole 612. A drilling platform 686 is equipped with a derrick 688 that supports a hoist. The drilling rig 602 can thus provide support for the drill string 608. The drill string 608 can operate to penetrate the rotary table 610 for drilling the borehole 612 through subsurface formations 614. The drill string 608 can include a Kelly 616, drill pipe 618, and a bottom hole assembly 620, perhaps located at the lower portion of the drill pipe 618. The bottom hole assembly 620 can include drill collars 622, a down hole tool 624, and a drill bit 626. The drill bit 626 can operate to create a borehole 612 by penetrating the surface 604 and subsurface formations 614. The down hole tool 624 can comprise any of a number of different types of tools including MWD tools, LWD tools, and others.

During drilling operations, the drill string 608 (perhaps including the Kelly 616, the drill pipe 618, and the bottom hole assembly 620) can be rotated by the rotary table 610. In addition to, or alternatively, the bottom hole assembly 620 can also be rotated by a motor (e.g., a mud motor) that is located down hole. The drill collars 622 can be used to add weight to the drill bit 626. The drill collars 622 may also operate to stiffen the bottom hole assembly 620, allowing the bottom hole assembly 620 to transfer the added weight to the drill bit 626, and in turn, to assist the drill bit 626 in penetrating the surface 604 and subsurface formations 614.

During drilling operations, a mud pump 632 can pump drilling fluid (sometimes known by those of ordinary skill in the art as “drilling mud”) from a mud pit 634 through a hose 636 into the drill pipe 618 and down to the drill bit 626. The drilling fluid can flow out from the drill bit 626 and be returned to the surface 604 through an annular area 640 between the drill pipe 618 and the sides of the borehole 612. The drilling fluid can then be returned to the mud pit 634, where such fluid is filtered. A computing device 600 can monitor the drilling fluid as it flows through the hose 636. The computing device 600 can be in communication with an operator and the operator can logs tasks performed by the system 664. A drilling analytics system running on the computing device 600 can use predictive models to correct drilling data in the tasks logged by the operator. In some embodiments, the drilling fluid can be used to cool the drill bit 626, as well as to provide lubrication for the drill bit 626 during drilling operations. Additionally, the drilling fluid can be used to remove subsurface formation 614 cuttings created by operating the drill bit 626. It is the images of these cuttings that many embodiments operate to acquire and process.

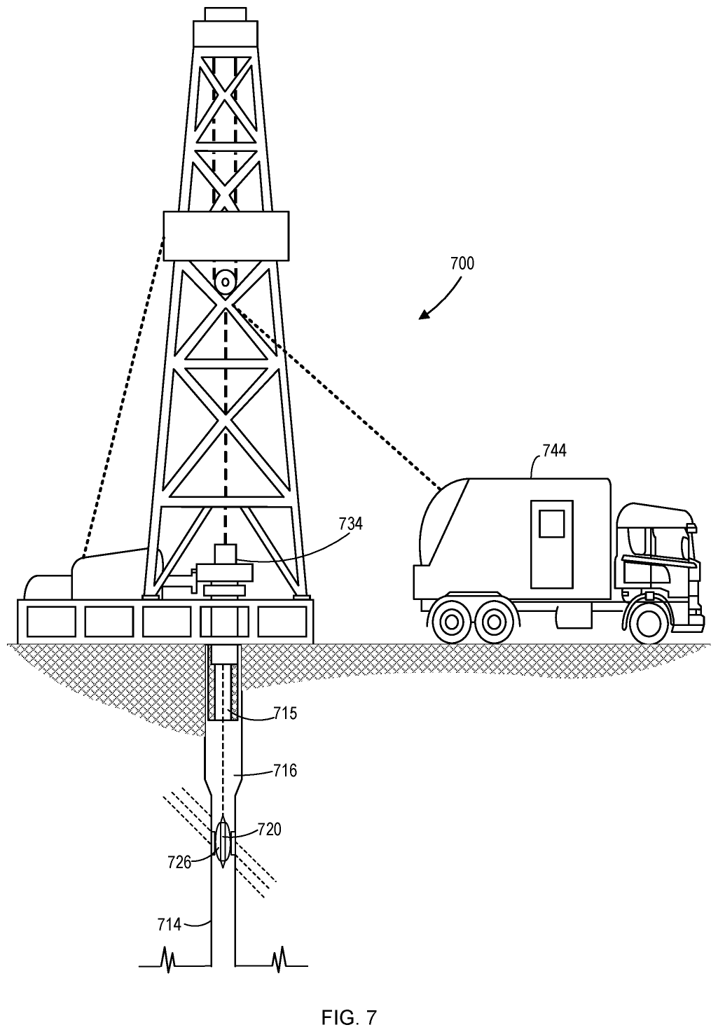

FIG. 7 depicts a schematic diagram of a wireline system with a drilling analytics system. A system 700 can be used in an illustrative logging environment with a drillstring removed, in accordance with some embodiments of the present disclosure. Subterranean operations can be conducted using a wireline system 720 once the drillstring has been removed, though, at times, some or all of the drillstring can remain in a borehole 714 during logging with the wireline system 720. The wireline system 720 can include one or more logging tools 726 that can be suspended in the borehole 714 by a conveyance 715 (e.g., a cable, slickline, or coiled tubing). The logging tool 726 can be communicatively coupled to the conveyance 715. The conveyance 715 can contain conductors for transporting power to the wireline system 720 and telemetry from the logging tool 726 to a logging facility 744. Alternatively, the conveyance 715 can lack a conductor, as is often the case using slickline or coiled tubing, and the wireline system 720 can contain a control unit 734 that contains memory, one or more batteries, and/or one or more processors for performing operations and storing measurements. The logging facility 744 can store data for tasks manually input by an operator of the system 700. A drilling analytics system running on the logging facility 744 can detect bad drilling data in the logs of tasks input by the operator and can use predictive models to correct bad data entries as described variously herein.

In certain embodiments, the control unit 734 can be positioned at the surface, in the borehole (e.g., in the conveyance 715 and/or as part of the logging tool 726) or both (e.g., a portion of the processing can occur downhole and a portion can occur at the surface). The control unit 734 can include a control system or a control algorithm. In certain embodiments, a control system, an algorithm, or a set of machine-readable instructions can cause the control unit 734 to generate and provide an input signal to one or more elements of the logging tool 726, such as the sensors along the logging tool 726. The input signal can cause the sensors to be active or to output signals indicative of sensed properties. The logging facility 744 (shown in FIG. 7 as a truck, although it can be any other structure) can collect measurements from the logging tool 726, and can include computing facilities for controlling, processing, or storing the measurements gathered by the logging tool 726. The computing facilities can be communicatively coupled to the logging tool 726 by way of the conveyance 715 and can operate similarly to the control unit 734. In certain example embodiments, the control unit 734, which can be located in logging tool 726, can perform one or more functions of the computing facility.

The logging tool 726 includes a mandrel and a number of extendible arms coupled to the mandrel. One or more pads are coupled to each of the extendible arms. Each of the pads have a surface facing radially outward from the mandrel. Additionally, at least sensor disposed on the surface of each pad. During operation, the extendible arms are extended outwards to a wall of the borehole to extend the surface of the pads outward against the wall of the borehole. The sensors of the pads of each extendible arm can detect image data to create captured images of the formation surrounding the borehole.

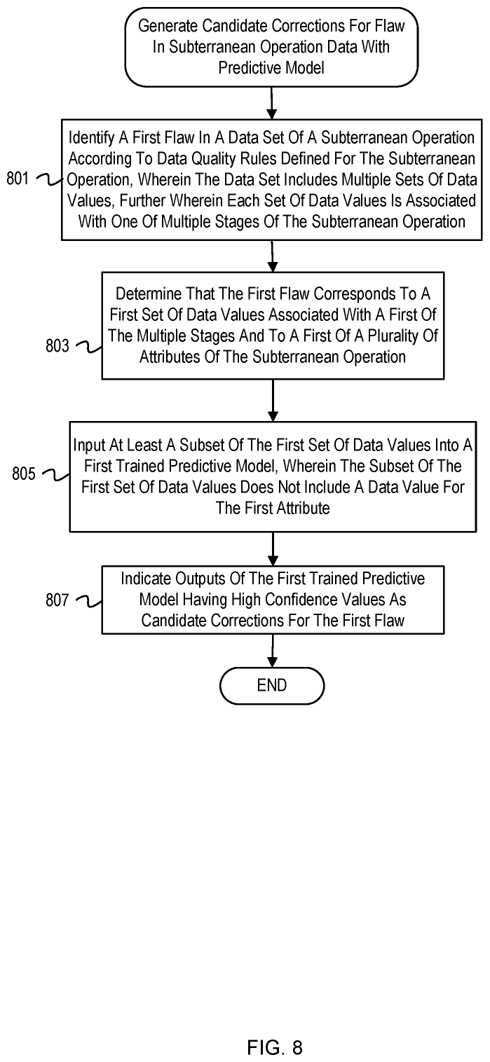

FIG. 8 is a flowchart that discloses the present technology in broader/distinct terminology as an attempt to account for the shortcoming of language to describe novel technology. For instance, the term “predictive” is used to generically refer to a model for estimation of drilling data attribute values regardless of internal architecture or model type. These flowcharts do not refer to a specific actor since there are numerous implementations for organizing and developing program code, as well as various choices for deployment on different hardware and/or virtualization.

FIG. 8 is a flowchart of example operations for generating candidate corre3ctions for a flaw in subterranean operation data with a predictive model. At block 801, a drilling data analytics engine identifies a first flaw in a data set of a subterranean operation according to data quality rules defined for the subterranean operations, wherein the data set includes multiple sets of data values, further wherein each set of data values is associated with one of multiple stages of the subterranean operation. Identification of a flaw can be performed by a drilling data quality analyzer that is pretrained on flawed and correct drilling data entries specific to drilling data attributes. The multiples stages of the subterranean operation can be, for instance, specific tasks recorded by an operation of the subterranean operation.

At block 803, the drilling data analytics engine determines that the first flaw corresponds to a first set of data values associated with a first of the multiple stages and to a first of a plurality of attributes of the subterranean operation. For instance, the first set of data values can be values for data attributes of a task corresponding to the first of the multiple stages. The first set of data values can be stored as a row of values for the task that has a missing, incorrect, or incomplete data entry corresponding to the first flaw.

At block 805, the drilling data analytics engine inputs at least a subset of the first set of data values into a first trained predictive model, wherein the subset of the first set of data values does not include a data value for the first attribute. The subset of the first set of data values can be a row of data values for a task of the subterranean operation that omits one or more flawed data entries including the first flaw.

At block 807, the drilling data analytics engine indicates outputs of the first trained predictive model having high confidence values as candidate corrections for the first flaw. The candidate corrections can be presented as a drop-down menu from a data entry in a table of data values for the subterranean operation. The outputs can be chosen as being outputs with confidence values above a threshold confidence value.

While the aspects of the disclosure are described with reference to various implementations and exploitations, it will be understood that these aspects are illustrative and that the scope of the claims is not limited to them. In general, techniques for completion of bad data entries in drilling operation data using predictive drilling models for each drilling attribute in the bad data entries as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### EXAMPLE EMBODIMENTS

Embodiment 1: A method comprising identifying a first flaw in a data set of a subterranean operation according to data quality rules defined for the subterranean operation, wherein the data set includes multiple sets of data values, further wherein each set of data values is associated with one of multiple stages of the subterranean operation, determining that the first flaw corresponds to a first set of data values associated with a first of the multiple stages and to a first of a plurality of attributes of the subterranean operation, inputting at least a subset of the first set of data values into a first trained predictive model, wherein the subset of the first set of data values does not include a data value for the first attribute, and indicating outputs of the first trained predictive model having high confidence values as candidate corrections for the first flaw.

Embodiment 2: The method of Embodiment 1, wherein each set of data values is associated with at least one of a set of one or more tasks for the subterranean operation.

Embodiment 3: The method of Embodiment 2, wherein the set of one or more tasks for the subterranean operation comprises a set of one or more downhole operations performed by an operator of the subterranean operation.

Embodiment 4: The method of any of Embodiments 1-3, further comprising identifying a subset of the data set of the subterranean operation without flaws according to the data quality rules defined for the subterranean operation and training a predictive model to estimate data values for the first attribute based, at least in part, on the subset of the data set of the subterranean operation, wherein training the predictive model generates the first trained predictive model.

Embodiment 5: The method of any of Embodiments 1-4, wherein the first flaw in the data set of the subterranean operation comprises at least one of a missing data value, an incorrect data value, and an incomplete data value.

Embodiment 6: The method of any of Embodiments 1-5, further comprising replacing a data value corresponding to the first flaw in the data set of the subterranean operation with one of the candidate corrections for the first flaw.

Embodiment 7: The method of Embodiment 6, wherein replacing the data values corresponding to the first flaw in the data set of the subterranean operation with one of the candidate corrections for the first flaw comprises replacing the data values in response to a selection of one of the candidate corrections.

Embodiment 8: The method of any of Embodiments 1-7, further comprising preprocessing the subset of the first set of data values with natural language processing.

Embodiment 9: The method of any of Embodiments 1-8, further comprising computing similarities between a data value corresponding to the first flaw in the data set and correct data values for the first attribute in the data set and inputting the similarities in addition to the subset of the first set of data values into the first trained predictive model.

Embodiment 10: One or more non-transitory machine-readable media comprising program code to identify a first flaw in a data set of a subterranean operation according to data quality rules defined for the subterranean operation, wherein the data set includes multiple sets of data values, further wherein each set of data values is associated with one of multiple stages of the subterranean operation, determine that the first flaw corresponds to a first set of data values associated with a first of the multiple stages and to a first of a plurality of attributes of the subterranean operation, input at least a subset of the first set of data values into a first trained predictive model, wherein the subset of the first set of data values does not include a data value for the first attribute, and indicate outputs of the first trained predictive model having high confidence values as candidate corrections for the first flaw.

Embodiment 11: The non-transitory machine-readable media of Embodiment 10, wherein each set of data values is associated with at least one of a set of one or more tasks for the subterranean operation.

Embodiment 12: The non-transitory machine-readable media Embodiment 11, wherein the set of one or more tasks for the subterranean operation comprises a set of one or more downhole operations performed by an operator of the subterranean operation.

Embodiment 13: The non-transitory machine-readable media of any of Embodiments 10-12, further comprising program code to identify a subset of the data set of the subterranean operation without flaws according to the data quality rules defined for the subterranean operation, and train a predictive model to estimate data values for the first attribute based, at least in part, on the subset of the data set of the subterranean operation, wherein training the predictive model generates the first trained predictive model.

Embodiment 14: The non-transitory machine-readable media of any of Embodiments 10-13, wherein the first flaw in the data set of the subterranean operation comprises at least one of a missing data value, an incorrect data value, and an incomplete data value.

Embodiment 15: The non-transitory machine-readable media of any of Embodiments 10-14, further comprising program code to replace a data value corresponding to the first flaw in the data set of the subterranean operation with one of the candidate corrections for the first flaw.

Embodiment 16: The non-transitory machine-readable media of Embodiment 15, wherein the program code to replace the data values corresponding to the first flaw in the data set of the subterranean operation with one of the candidate corrections for the first flaw comprises program code to replace the data values in response to a selection of one of the candidate corrections.

Embodiment 17: The non-transitory machine-readable media of any of Embodiments 10-16, further comprising program code to preprocess the subset of the first set of data values with natural language processing.

Embodiment 18: The non-transitory machine-readable media of any of Embodiments 10-17, further comprising program code to compute similarities between a data value corresponding to the first flaw in the data set and correct data values for the first attribute in the data set and input the similarities in addition to the subset of the first set of data values into the first trained predictive model.

Embodiment 19: An apparatus comprising a processor and a machine-readable medium having program code executable by the processor to cause the apparatus to identify a first flaw in a data set of a subterranean operation according to data quality rules defined for the subterranean operation, wherein the data set includes multiple sets of data values, further wherein each set of data values is associated with one of multiple stages of the subterranean operation, determine that the first flaw corresponds to a first set of data values associated with a first of the multiple stages and to a first of a plurality of attributes of the subterranean operation, input at least a subset of the first set of data values into a first trained predictive model, wherein the subset of the first set of data values does not include a data value for the first attribute, and indicate outputs of the first trained predictive model having high confidence values as candidate corrections for the first flaw.

Embodiment 20: The apparatus of Embodiment 19, wherein each set of data values is associated with at least one of a set of one or more tasks for the subterranean operation.

What is claimed is:

1. A method comprising:
identifying a first flaw in a data set of a subterranean operation according to data quality rules defined for the subterranean operation, wherein the data set includes multiple sets of data values, further wherein each set of data values is associated with one of multiple stages of the subterranean operation;
determining that the first flaw corresponds to a first set of data values associated with a first of the multiple stages and to a first of a plurality of attributes of the subterranean operation;
inputting at least a subset of the first set of data values into a first trained predictive model, wherein the subset of the first set of data values does not include a data value for the first attribute; and
indicating outputs of the first trained predictive model having high confidence values as candidate corrections for the first flaw.

2. The method of claim 1, wherein each set of data values is associated with at least one of a set of one or more tasks for the subterranean operation.

3. The method of claim 2, wherein the set of one or more tasks for the subterranean operation comprises a set of one or more downhole operations performed by an operator of the subterranean operation.

4. The method of claim 1, further comprising,
identifying a subset of the data set of the subterranean operation without flaws according to the data quality rules defined for the subterranean operation; and
training a predictive model to estimate data values for the first attribute based, at least in part, on the subset of the data set of the subterranean operation, wherein training the predictive model generates the first trained predictive model.

5. The method of claim 1, wherein the first flaw in the data set of the subterranean operation comprises at least one of a missing data value, an incorrect data value, and an incomplete data value.

6. The method of claim 1, further comprising replacing a data value corresponding to the first flaw in the data set of the subterranean operation with one of the candidate corrections for the first flaw.

7. The method of claim 6, wherein replacing the data value corresponding to the first flaw in the data set of the subterranean operation with one of the candidate corrections for the first flaw comprises replacing the data value in response to a selection of one of the candidate corrections.

8. The method of claim 1, further comprising preprocessing the subset of the first set of data values with natural language processing.

9. The method of claim 1, further comprising,
computing similarities between a data value corresponding to the first flaw in the data set and correct data values for the first attribute in the data set; and
inputting the similarities in addition to the subset of the first set of data values into the first trained predictive model.

10. One or more non-transitory machine-readable media comprising program code to:
identify a first flaw in a data set of a subterranean operation according to data quality rules defined for the subterranean operation, wherein the data set includes multiple sets of data values, further wherein each set of data values is associated with one of multiple stages of the subterranean operation;
determine that the first flaw corresponds to a first set of data values associated with a first of the multiple stages and to a first of a plurality of attributes of the subterranean operation;
input at least a subset of the first set of data values into a first trained predictive model, wherein the subset of the first set of data values does not include a data value for the first attribute; and
indicate outputs of the first trained predictive model having high confidence values as candidate corrections for the first flaw.

11. The non-transitory machine-readable media of claim 10, wherein each set of data values is associated with at least one of a set of one or more tasks for the subterranean operation.

12. The non-transitory machine-readable media of claim 11, wherein the set of one or more tasks for the subterranean operation comprises a set of one or more downhole operations performed by an operator of the subterranean operation.

13. The non-transitory machine-readable media of claim 10, further comprising program code to,
identify a subset of the data set of the subterranean operation without flaws according to the data quality rules defined for the subterranean operation; and
train a predictive model to estimate data values for the first attribute based, at least in part, on the subset of the data set of the subterranean operation, wherein training the predictive model generates the first trained predictive model.

14. The non-transitory machine-readable media of claim 10, wherein the first flaw in the data set of the subterranean operation comprises at least one of a missing data value, an incorrect data value, and an incomplete data value.

15. The non-transitory machine-readable media of claim 10, further comprising program code to replace a data value corresponding to the first flaw in the data set of the subterranean operation with one of the candidate corrections for the first flaw.

16. The non-transitory machine-readable media of claim 15, wherein the program code to replace the data value corresponding to the first flaw in the data set of the subterranean operation with one of the candidate corrections for the first flaw comprises program code to replace the data value in response to a selection of one of the candidate corrections.

17. The non-transitory machine-readable media of claim 10, further comprising program code to preprocess the subset of the first set of data values with natural language processing.

18. The non-transitory machine-readable media of claim 10, further comprising program code to,
compute similarities between a data value corresponding to the first flaw in the data set and correct data values for the first attribute in the data set; and
input the similarities in addition to the subset of the first set of data values into the first trained predictive model.

19. An apparatus comprising:
a processor; and
a machine-readable medium having program code executable by the processor to cause the apparatus to,
identify a first flaw in a data set of a subterranean operation according to data quality rules defined for the subterranean operation, wherein the data set includes multiple sets of data values, further wherein each set of data values is associated with one of multiple stages of the subterranean operation;
determine that the first flaw corresponds to a first set of data values associated with a first of the multiple stages and to a first of a plurality of attributes of the subterranean operation;
input at least a subset of the first set of data values into a first trained predictive model, wherein the subset of the first set of data values does not include a data value for the first attribute; and
indicate outputs of the first trained predictive model having high confidence values as candidate corrections for the first flaw.

20. The apparatus of claim 19, wherein each set of data values is associated with at least one of a set of one or more tasks for the subterranean operation.
